(19) United States
(12) Patent Application Publication
(10) Pub. No.: US 2025/0198865 A1
(43) Pub. Date: Jun. 19, 2025

(54) DEADLINE ANCHOR WITH LOAD SENSORS

(71) Applicant: Nabors Drilling Technologies USA, Inc., Houston, TX (US)

(72) Inventors: David SILJEG, Conroe, TX (US); Derek PATTERSON, Houston, TX (US)

(21) Appl. No.: 18/985,188

(22) Filed: Dec. 18, 2024

Related U.S. Application Data
(60) Provisional application No. 63/611,268, filed on Dec. 18, 2023.

(51) Int. Cl. G01L 5/10; E21B 19/00

(52) U.S. Cl. CPC G01L 5/10; E21B 19/008

(57) ABSTRACT

A deadline anchor can include a base structure coupled to a rig floor, a wheel rotatably coupled to the base structure, a first sensor coupled to the deadline anchor at a first location, where the first sensor detects a first force, and a second sensor coupled to the deadline anchor at a second location, where the second sensor detects a second force. A method can include coupling a first sensor to a deadline anchor at a first location, coupling a second sensor to the deadline anchor at a second location, applying a tension force to the deadline anchor, where the tension force is proportional to an actual hook load, detecting a first force, via the first sensor, in response to applying the tension force, and detecting a second force, via the second sensor, in response to applying the tension force.

### CROSS-REFERENCE TO RELATED APPLICATION(S)

This application claims priority under 35 U.S.C. § 119 (e) to U.S. Provisional Patent Application No. 63/611,268, filed on Dec. 18, 2023, entitled “DEADLINE ANCHOR WITH LOAD SENSORS,” by David SILJEG et al., which is assigned to the current assignee hereof and is incorporated herein by reference in its entirety.

### FIELD OF THE DISCLOSURE

The present invention relates, in general, to the field of drilling and processing of wells. More particularly, present embodiments relate to a system and method for measuring tension on a drilling line during subterranean operations.

### BACKGROUND

Existing technology involves a deadline anchor with a hydraulic load cell which detects static and dynamic pull in the drilling line and transforms the tension or compression force into a pressure signal (i.e., the hydraulic system of the hydraulic load cell gets pressurized as the force is applied to the hydraulic load cell). The pressure signal drives a gauge (i.e., a weight indicator) to visualize the hook load or weight on bit (WOB) for the operator(s). The pressure signal can act on a bourdon tube of the gauge, which moves the pointer around a dial proportionally to the hook load through precise gearing elements inside the gauge. Existing systems are purely mechanical and hydraulic with a few dependable components needed to provide the end result of a hook load numeric value from the pressure signal generated by the hydraulic load cell.

Existing systems can include a deadline anchor, a hydraulic load cell, hydraulic fittings and hoses for connecting the hydraulic load cell to a weight indicator, a gauge (i.e., a weight indicator) that generally includes a bourdon tube, a gearing mechanism, a hook load dial, a weight on bit (WOB) dial, and a pressure transducer which picks up the pressure signal from the hydraulic load cell and transforms it to an analog electrical signal.

Generally, the hydraulic load cell and the gauge require frequent calibration and recertification by a third party. After a rig move, or hydraulic disconnects, the hydraulic load cell usually requires adjustments (e.g., gap clearance vs. tolerance), hydraulic fluid control, purging to release air trapped in the system, etc. All these procedures can cause errors in the gauge readings, such as when 1) air bubbles are trapped in the system, 2) there is insufficient hydraulic fluid in the system, 3) a gap clearance on the hydraulic load cell is outside the operating specifications, 4) the hydraulic system is leaking, 5) the gauge has a faulty mechanism, 6) temperature causes expansion or contraction, and etc. Additionally, there are no verification markers in case these errors occur and no verification of the hook load and WOB readings while drilling. Therefore, improvements in hook load and WOB measuring systems are continually needed.

### SUMMARY

This summary is provided to introduce a selection of concepts that are further described below in the detailed description. This summary is not intended to identify indispensable features of the claimed subject matter, nor is it intended for use as an aid in limiting the scope of the claimed subject matter.

One general aspect includes a deadline anchor with a base structure coupled to a rig floor; a wheel rotatably coupled to the base structure; a first sensor coupled to the deadline anchor at a first location, where the first sensor is configured to detect a first force applied to the first sensor; and a second sensor coupled to the deadline anchor at a second location, where the second sensor is configured to detect a second force applied to the second sensor.

One general aspect includes a system for determining hook load a drilling line coupled to a drawworks at one end and to a deadline anchor at an opposite end, the deadline anchor may include: a base structure coupled to a rig floor; a wheel rotatably coupled to the base structure; a first sensor coupled to the wheel at a first location, where the first sensor detects a first force that is proportional to a tension force applied to the deadline anchor via the drilling line; and a second sensor coupled to the wheel at a second location, where the second sensor detects a second force that is proportional to the tension force.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for verifying hook load. The method also includes coupling a first sensor to a deadline anchor at a first location; coupling a second sensor to the deadline anchor at a second location; applying a tension force to the deadline anchor, where the tension force is proportional to an actual hook load; detecting a first force, via the first sensor, in response to applying the tension force; and detecting a second force, via the second sensor, in response to applying the tension force. Other embodiments of this aspect include corresponding computer systems, apparatus, and computer programs recorded on one or more computer storage devices, each configured to perform the actions of the methods.

One general aspect includes a method for verifying hook load. The method also includes coupling a first sensor to a deadline anchor at a first location; coupling a second sensor to the deadline anchor at a second location; applying a tension force to the deadline anchor, where the tension force is proportional to an actual hook load; detecting a first force, via the first sensor, in response to applying the tension force; and detecting a second force, via the second sensor, in response to applying the tension force. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIGS. 1A and 1B are representative partial cross-section views of a rig used to perform subterranean operations, in accordance with certain embodiments;

FIG. 2 is a representative perspective view of a deadline anchor on a rig for securing an end of a drilling line, in accordance with certain embodiments;

FIGS. 3A, 3B, and 3C are representative partial cross-section views of configurations for a load pin that can be used to measure forces acting on a deadline anchor, in accordance with certain embodiments;

FIGS. 4A, 4B, and 4C are representative perspective, side, and end views, respectively, of a deadline anchor with load sensors for measuring forces acting on the deadline anchor, in accordance with certain embodiments;

FIG. 5 is a representative perspective view of another deadline anchor with load sensors for measuring forces acting on the deadline anchor, in accordance with certain embodiments;

FIG. 6 is a representative perspective view of another deadline anchor with load sensors for measuring forces acting on the deadline anchor, in accordance with certain embodiments;

FIG. 7 is a representative functional block diagram of a rig controller that can control rig equipment of the rig 10 and perform methods of the current disclosure, in accordance with certain embodiments; and

FIG. 8 is a representative front view of a graphic user interface display for hook load and WOB.

FIG. 9 is a representative flow chart for a method for determining confidence scores.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

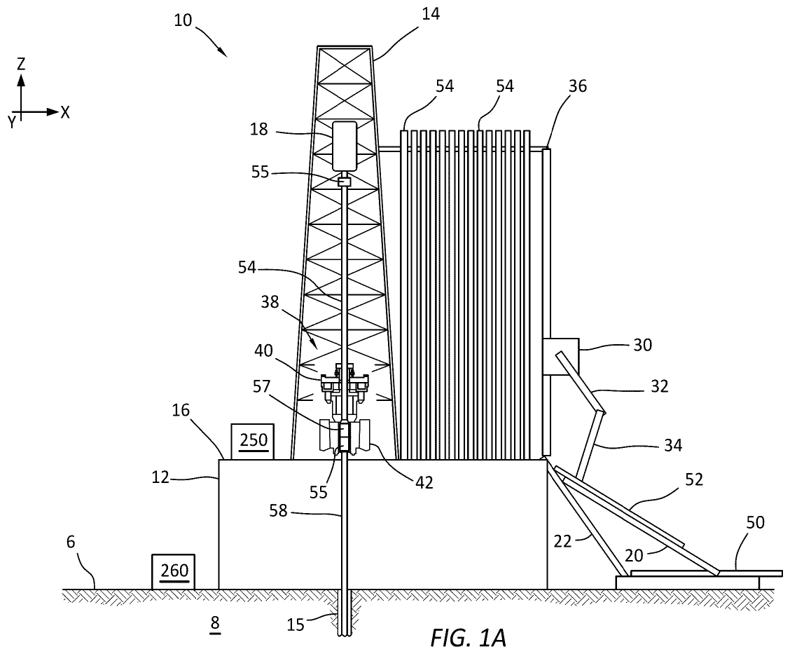

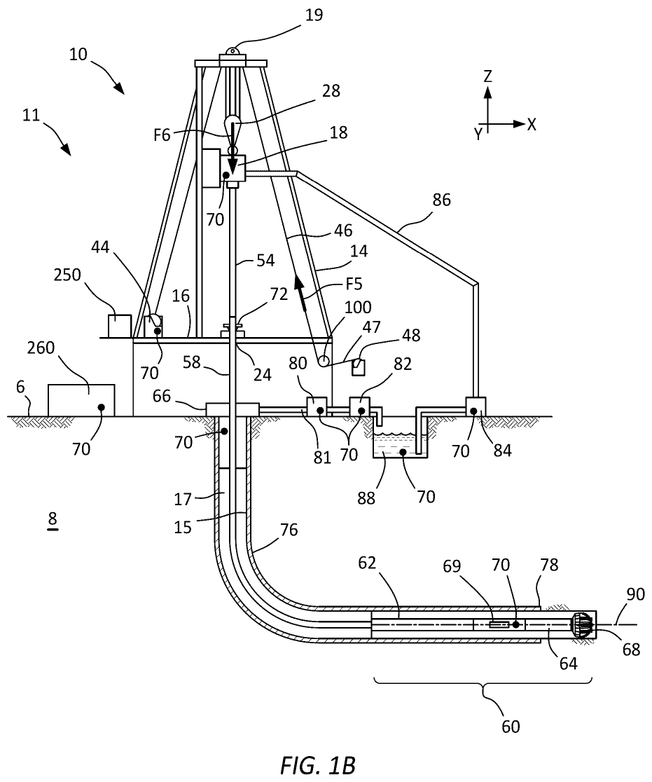

FIG. 1A is a representative simplified front view of a rig being utilized for a subterranean operation (e.g., tripping in or out a tubular string 58 to or from a wellbore 15), in accordance with certain embodiments. The rig 10 can include a platform 12 with a rig floor 16 and a derrick 14 extending up from the rig floor 16. The derrick 14 can provide support for hoisting the top drive 18 as needed to manipulate tubulars. A catwalk 20 and V-door ramp 22 can be used to transfer horizontally stored tubular segments 50 to the rig floor 16. A tubular segment 52 can be one of the horizontally stored tubular segments 50 that is being transferred to the rig floor 16 via the catwalk 20. A pipe handler 30 with articulating arms 32, 34 can be used to grab the tubular segment 52 from the catwalk 20 and transfer the tubular segment 52 to the top drive 18, the vertical storage area 36, the wellbore 15, etc. However, it is not required that a pipe handler 30 be used on the rig 10. The top drive 18 can transfer tubulars directly between the catwalk 20 and the top drive 18 (e.g., using an elevator coupled to the top drive).

The tubular string 58 can extend into the wellbore 15, with the wellbore 15 extending through the surface 6 into the subterranean formation 8. When tripping the tubular string 58 into the wellbore 15, tubulars 54 are sequentially added to the tubular string 58 to extend the length of the tubular string 58 into the earthen formation 8. The top drive 18 and slips 72 (e.g., at well center 24) can cooperate together to support adding or removing tubulars 54 to or from the tubular string 58. FIG. 1A shows a land-based rig. However, it should be understood that the principles of this disclosure are equally applicable to off-shore rigs where “off-shore” refers to a rig with water between the rig floor and the earth surface 6.

When tripping the tubular string 58 out of the wellbore 15, tubulars 54 are sequentially removed from the tubular string 58 to reduce the length of the tubular string 58 in the wellbore 15. The pipe handler 30 can be used to deliver the tubulars 54 to a well center on the rig floor 16 in a vertical orientation and hand the tubulars 54 off to an iron roughneck 38 or a top drive 18. The pipe handler 30 can also be used to remove the tubulars 54 from the well center in a vertical orientation and receive the tubulars 54 from the iron roughneck 38 or a top drive 18. The iron roughneck 38 can make a threaded connection between a tubular 54 being added and the tubular string 58. A spinner assembly 40 can engage a body of the tubular 54 to spin a pin end 57 of the tubular 54 into a threaded box end 55 of the tubular string 58, thereby threading the tubular 54 into the tubular string 58. The wrench assembly 42 can provide a desired torque to the threaded connection, thereby completing the connection. This process can be reversed when the tubulars 54 are being removed from the tubular string 58.

A rig controller 250 can be used to control rig operations including controlling various rig equipment, such as a pipe handler 30, the top drive 18, an iron roughneck 38, fingerboard equipment, imaging systems, various other robots on the rig 10 (e.g., a drill floor robot), or rig power systems 260. The rig controller 250 can control the rig equipment autonomously (e.g., without periodic operator interaction,), semi-autonomously (e.g., with limited operator interaction such as initiating a subterranean operation, adjusting parameters during the operation, etc.), or manually (e.g., with the operator interactively controlling the rig equipment via remote control interfaces to perform the subterranean operation). A portion of the rig controller 250 can also be distributed around the rig 10, such as having a portion of the rig controller 250 in the pipe handler 30 and the iron roughneck 38 or at one or more various locations around the rig 10 or remote from the rig 10.

FIG. 1B is a representative partial cross-sectional front view of a rig 10 at a rig site 11 being used to drill a wellbore 15 in a subterranean formation 8, in accordance with certain embodiments. Rig 10 can include a top drive 18 with a drawworks 44, sheaves 19, traveling block 28, deadline anchor 100, and reel 48 used to raise or lower the top drive 18 via a drilling line 46. A derrick 14 extending from the rig floor 16, can provide the structural support of the rig equipment for performing subterranean operations (e.g., drilling, treating, completing, producing, testing, etc.).

The rig can be used to extend a wellbore 15 through the subterranean formation 8 by using a tubular string 58 having a bottom hole assembly (BHA) 60 at its lower end. The BHA 60 can include a drill bit 68 and multiple drill collars 62, 64 with one or more of the drill collars including one or more sensors 70 or one or more tools 69 for Logging While Drilling (LWD) or Measuring While Drilling (MWD) operations. During drilling operations, drilling mud can be pumped from the surface 6 into the tubular string 58 (e.g., via pumps 84 supplying mud to the top drive 18 via the standpipe 86) to cool and lubricate the drill bit 68 and to transport cuttings to the surface via an annulus 17 between the tubular string 58 and the wellbore 15.

The returned mud can be directed to the mud pit 88 from a rotating control device 66, through the flow line 81, to the shaker 80. A fluid treatment 82 can inject additives as desired to the mud to condition the mud appropriately for the current well activities and possibly future well activities as the mud is being pumped to the mud pit 88. Pump 84 can pull mud from the mud pit 88 and drive it to the top drive 18, via standpipe 86, to continue circulation of the mud through the tubular string 58.

The wellbore 15 can have casing string 76 installed in the wellbore 15 and extending down to a casing shoe 78. The portion of the wellbore 15 with the casing string 76 installed, can be referred to as a cased wellbore. The portion of the wellbore 15 below the shoe 78, without casing, can be referred to as an “uncased” or “open hole” wellbore. The wellbore 15 can be extended by rotating the drill bit 68 and cutting into the earthen formation 8. The rate at which the drill bit 68 progresses into the subterranean formation 8 can be referred to as a rate of penetration (ROP).

The rig controller 250 can include one or more processors with one or more of the processors distributed about the rig 10, such as in an operator's control hut, in a pipe handler 30, in an iron roughneck 38, in a vertical storage area 36, in the imaging systems, in various other robots, in the top drive 18, at various locations on the rig floor 16 or the derrick 14 or the platform 12, at a remote location off of the rig 10, at downhole locations, etc. It should be understood that any of these processors can perform control or calculations locally or can communicate to a remotely located processor for performing the control or calculations. Each of the processors can be communicatively coupled to a non-transitory memory, which can include instructions for the respective processor to read and execute to implement the desired control functions or other methods described in this disclosure. These processors can be coupled via a wired or wireless network 154.

The rig controller 250 can collect data from various data sources (e.g., sensors 70, 102, 200) around the rig and downhole (e.g., sensor data via mud pulse telemetry, EM telemetry, etc.) and from remote data sources (e.g., suppliers, manufacturers, transporters, company men, remote rig reports, etc.) to monitor and facilitate the execution of the subterranean operation and control ROP during drilling operations.

During rig operations, the top drive 18 can be raised or lowered by a drawworks 44 that winds and unwinds a drilling line 46, which can be threaded through the sheaves 19 and traveling block 28 and secured at another end by a deadline anchor 100. The deadline anchor 100 securely holds an end of the drilling line 46 while the drawworks 44 manipulates the drilling line 46 at an opposite end of the drilling line 46, thereby causing the block and tackle arrangement of the sheaves 19 and the traveling block 28 to raise and lower the traveling block 28, and thus raise and lower the top drive 18.

The sheaves 19 and traveling block 28 operate to raise and lower the top drive 18 with the weight of the traveling block 28, the top drive 18, and the tubular string 58 (when it is hanging from the top drive 18) causing tension in the drilling line 46. The tension force F5 in the drilling line 46 can be proportional to the weight it is helping to support. Because of the block and tackle arrangement of the sheaves 19 and the traveling block 28, the tension force F5 is a fraction of the total hook load F6 being supported by the traveling block 28.

Measuring the tension force F5 in the drilling line 46 can allow the hook load F6 to be determined, where the hook load F6 is the force exerted on the traveling block 28 due to the weight of the top drive 18, the tubular string 58, or any other equipment suspended from the traveling block 28. The hook load F6 can change when the drill bit 68 is on bottom in the wellbore 15, when a portion of the tubular string 58 lays along a horizontal portion of the wellbore 15, when the tubular string 58 is in the slips 72 (i.e., not suspended from the top drive 18), etc. As the weight suspended from the traveling block 28 changes, the tension force F5 in the drilling line 46 can change proportionally to the changes in the hook load F6.

As the drilling line 46 is used to manipulate the top drive 18 during rig operations, the drilling line 46 may need to be replaced due to best practices, fatigue, or damage. When replacement is desired, the deadline anchor 100 can be loosened to allow new drilling line 47 to be received from the reel 48 through the deadline anchor 100 and guided through the traveling block 28 and sheaves 19 and then wound onto the drawworks 44. The old drilling line 46 would have been previously removed from the drawworks 44 before receiving the new drilling line 47, which can then be referred to as the drilling line 46. The deadline anchor 100 can again be secured to the end of the drilling line 46.

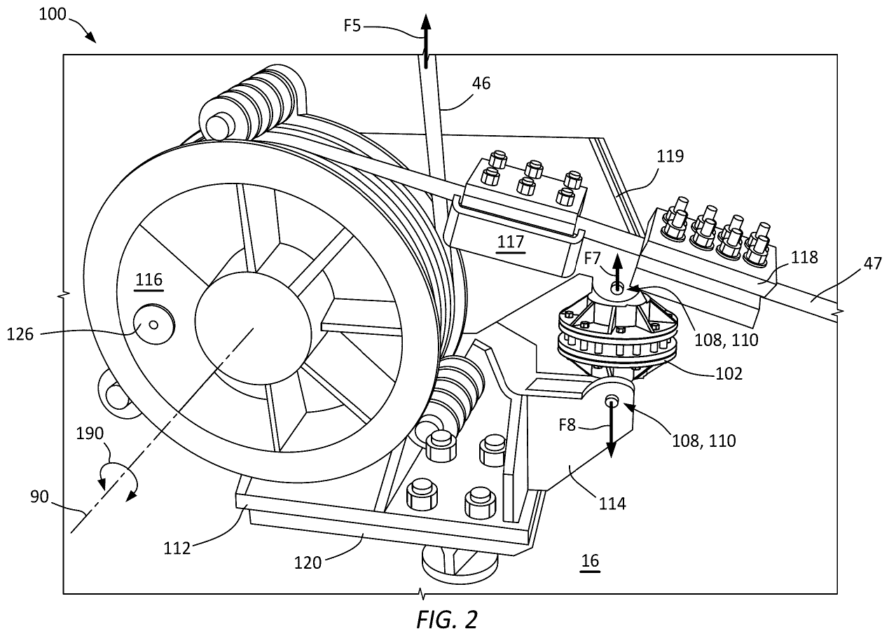

FIG. 2 is a representative perspective view of a deadline anchor 100 on a rig 10 for securing an end of a drilling line 46, in accordance with certain embodiments. A base 112 of the deadline anchor 100 can be secured to the rig floor 16 by a bracket 120, with the base 112 secured to the bracket 120 via one or more fasteners. A structure 114 can extend upward from the base 112 to support coupling the load sensor 102 to the base 112 and rotationally coupling the wheel 116 to the base 112. The wheel 116 can be rotated (arrows 190) about the axis 90 when the pin 126 is removed. The pin 126 can rotationally fix the wheel 116 to the structure 119, which can also be rotated (arrows 190) about the axis 90.

The drilling line 46 can extend from the clamp 118 through the clamp 117 to the wheel 116. The drilling line 46 can be wrapped around the wheel 116 by a desired number of wraps and can extend from the deadline anchor 100 to the sheaves 19. The drilling line 47 can extend from the clamp 118 to the reel 48. The clamp 117, when engaged with the drilling line 46, can secure the end of the drilling line 46 to the structure 119 (and to the wheel 116 when the pin 126 is installed). The clamp 118, when engaged with the drilling line 46, can secure the end of the drilling line 46 to the rig floor 16.

When a tension force F5 is applied to the drilling line 46, the wheel 116 can be urged to rotate about the axis 90. However, with the pin 126 installed, the tension force F5 can urge both the wheel 116 and the structure 119 to rotate about the axis 90. With the structure 119 coupled to a top end of the load sensor 102 and the bottom of the load sensor 102 coupled to the structure 114, applying the tension force F5 to the drilling line 46 will cause a force F7 to be applied to the top of the load sensor 102 with a reactive force F8 (e.g., equal and opposite to the force F7) acting on the bottom of the load sensor 102. These opposing forces F7, F8 can cause tension or compression in the load sensor 102 and create a pressure signal that is proportional to the tension force F5. In addition to the load sensor 102, one or more load sensors 200 (not shown) can be disposed at locations 108 in a sensor configuration 110. The one or more load sensors 200 can be used to provide redundant measurements for determining the tension force F5, and the hook load F6.

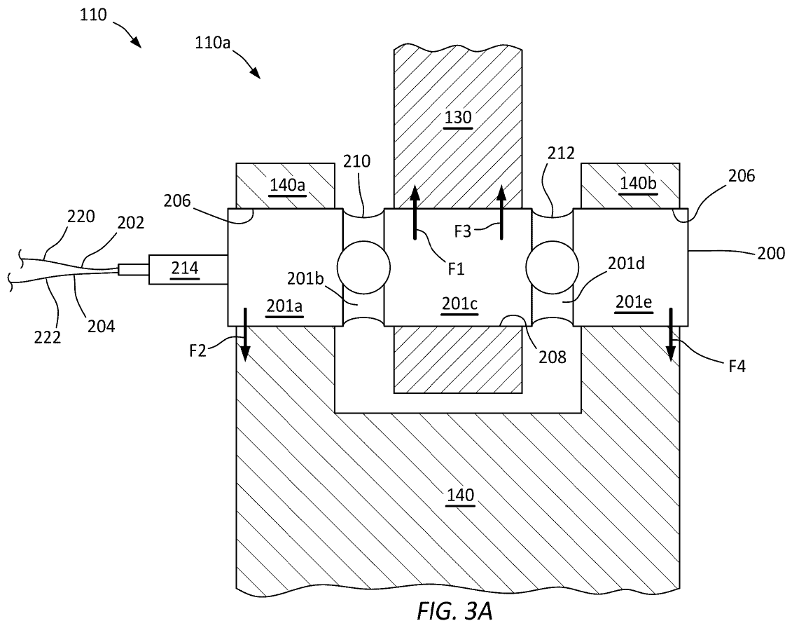

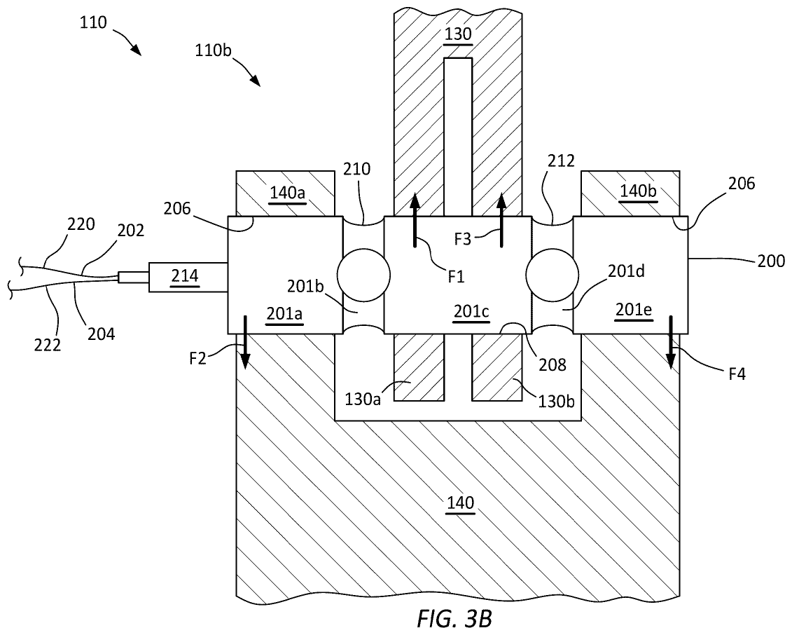

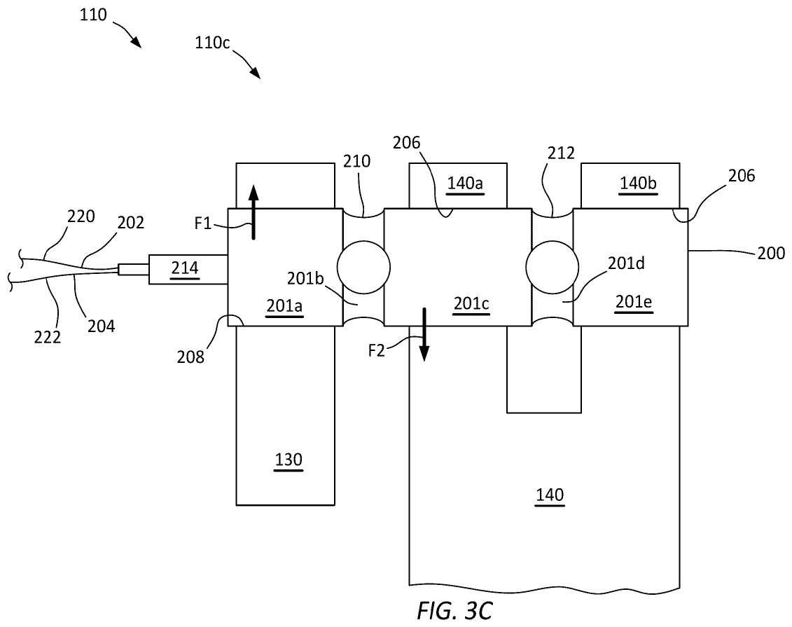

FIGS. 3A, 3B, and 3C are representative partial cross-section views of configurations 110 for a load pin 200 that can be used to measure forces acting on a deadline anchor 100, in accordance with certain embodiments. These configurations are non-limiting embodiments of using a load sensor 200 (e.g., a piezoelectric load cell) to measure tension or compression forces acting between the first and second structures 130, 140. One of ordinary skill in the art can envision other sensor configurations 110 than those described in this disclosure.

The load sensor 200 can include portions 201a and 201e at opposite ends of the load sensor 200, with the portion 201a positioned within the bore 206 in the end 140a of the second structure 140 and the portion 201e positioned within the bore 206 in the end 140b of the second structure 140. The middle portion 201c can be positioned within the bore 208 of the first structure 130. A first sensor 210 can be disposed in the portion 201b, that is positioned between the portions 201a, 201c. A second sensor 212 can be disposed in the portion 201d, that is positioned between the portions 201c, 201e. An additional sensor (not shown) can also be included in the load sensor 200, such that the load sensor 200 can generate three separate measurement signals.

Referring to FIG. 3A, a load sensor 200 can be arranged in the configuration 110a and positioned through bores 206, 208 that are aligned to receive the load sensor 200. The load sensor 200 can extend through bore 208 in the first structure 130 and through bore 206 in each of the ends 140a, 140b of the second structure 140. The first and second structures 130, 140 are independently moveable, if the load sensor 200 is not installed in the bores 206, 208. With the load sensor 200 installed in the bores 206, 208, forces acting on the first structure 130 to move it relative to the second structure 140 act on the second structure 140 through the load sensor 200. Therefore, the load sensor 200 can detect the forces acting on the first structure 130 to move it relative to the second structure 140.

For example, when tension forces F1, F3 (such as a tension force F5 applied to the drilling line 46) are applied to the middle portion 201c by the first structure 130, the second structure 140 can resist movement of the load sensor 200 by applying reactive forces F2, F4 to the portions 201a, 201e, thereby equalizing the forces such that the first structure 130 is substantially prevented from moving relative to the second structure 140. However, forces imparted to the load sensor 200 can be measured by the first and second sensors 210, 212 (and a third sensor in some embodiments). The forces are proportional to the tension forces F1, F3 as well as the reactive forces F2, F4. Each of the first and second sensors 210, 212 can generate signals 220, 222 that are representative of the forces and can transmit the resulting signals 220, 222 to a rig controller 250 via respective first and second communication links 202, 204 (which can be wired or wireless communication links). The communication links 202, 204 can be communicatively coupled to the load sensor 200 via interface 214.

In configuration 110a, the first and second sensors 210, 212 should detect similar forces. Therefore, the signals 220, 222 transmitted via the communication links 202, 204 to the rig controller 250 should be substantially equal. If they are not substantially equal, then a fault could be indicated. This redundancy can increase confidence in the transmitted signals 220, 222 that are representative of the forces F1, F2, F3, F4.

When configuration 110a is used for detecting the tension force F5 in the drilling line 46, the forces F1, F3 can be proportional (if not substantially equal) to the tension force F5, with forces F2, F4 being reactive forces that are substantially equal to the forces F1, F3. The tension force F5 can be proportional to the hook load F6. Therefore, the rig controller 250 can use the first or second signal 220, 222 to determine the hook load F6 and can display a hook load value via a graphical use interface (GUI). The rig controller 250 can also compare the first and second signals 220, 222 to detect when the signals are not substantially equal, which can indicate a failure of the load sensor 200 or some other failure.

Referring to FIG. 3B, a load sensor 200 can be arranged in the configuration 110b and positioned through bores 206, 208 that are aligned to receive the load sensor 200. Configuration 110b is similar to configuration 110a, except that the first and second structures 130, 140 are both bi-furcated structures, each with two spaced apart ends. The first structure 130 includes ends 130a, 130b, each with a bore 208 and the second structure 140 includes ends 140a, 140b, each with a bore 206. The load sensor 200 can extend through bore 208 in each of the ends 130a, 130b of the first structure 130 and through bore 206 in each of the ends 140a, 140b of the second structure 140. The rest of the description given above regarding FIG. 3A and the configuration 110a is also applicable for the configuration 110b of the load sensor 200 in FIG. 3B.

Referring to FIG. 3C, a load sensor 200 can be arranged in the configuration 110c and positioned through bores 206, 208 that are aligned to receive the load sensor 200. The load sensor 200 can extend through bore 208 in the first structure 130 and through bore 206 in each of the ends 140a, 140b of the second structure 140. The first and second structures 130, 140 are independently moveable, if the load sensor 200 is not installed in the bores 206, 208. With the load sensor 200 installed in the bores 206, 208, forces acting on the first structure 130 to move it relative to the second structure 140 act on the second structure 140 through the load sensor 200. Therefore, the load sensor 200 can detect the forces acting on the first structure 130 to move it relative to the second structure 140. The configuration 110c has the load sensor 200 held in position by the ends 140a, 140b and cantilevered from the end 140a to the first structure 130.

For example, when tension force F1 (such as a tension force F5 applied to the drilling line 46) is applied to the end portion 201a by the first structure 130, the second structure 140 can resist movement of the load sensor 200 by applying a reactive force F2 to the portion 201c, thereby equalizing the forces such that the first structure 130 is substantially prevented from moving relative to the second structure 140. However, forces imparted to the load sensor 200 can be measured by the first sensor 210. The second sensor 212 is not generally used in the configuration 110c. The forces are proportional to the tension force F1 as well as the reactive force F2. The first sensor 210 can generate a signal 220 that is representative of the forces and can transmit the resulting signal 220 to a rig controller 250 via the respective first communication link 202 (which can be a wired or wireless communication link). The communication link 202 can be communicatively coupled to the load sensor 200 via interface 214.

When configuration 110c is used for detecting the tension force F5 in the drilling line 46, the force F1 can be proportional (if not substantially equal) to the tension force F5, with force F2 being a reactive force that is substantially equal to the force F1. The tension force F5 can be proportional to the hook load F6. Therefore, the rig controller 250 can use the first signal 220 to determine the hook load F6 and can display a hook load value via a graphical use interface (GUI).

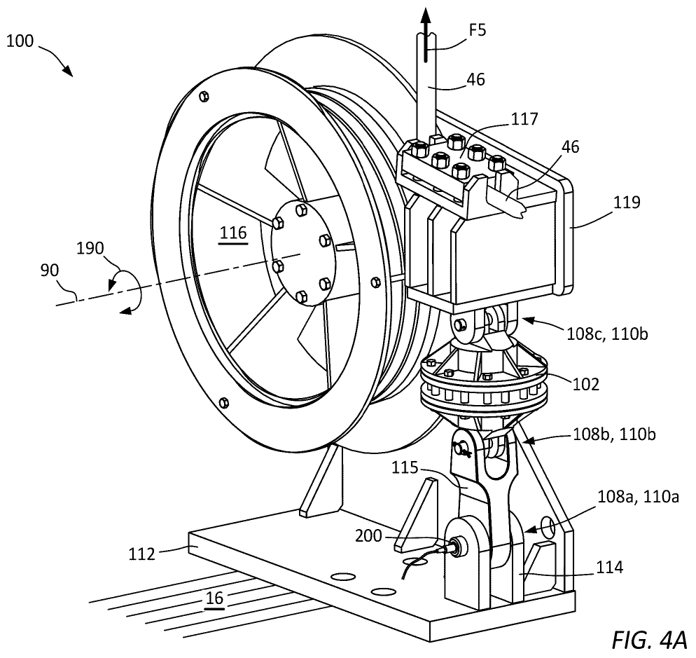

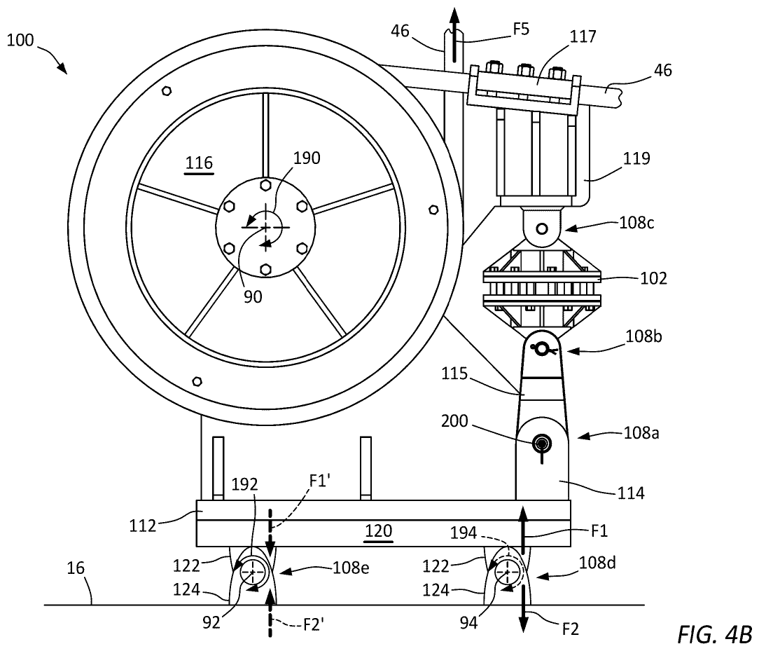

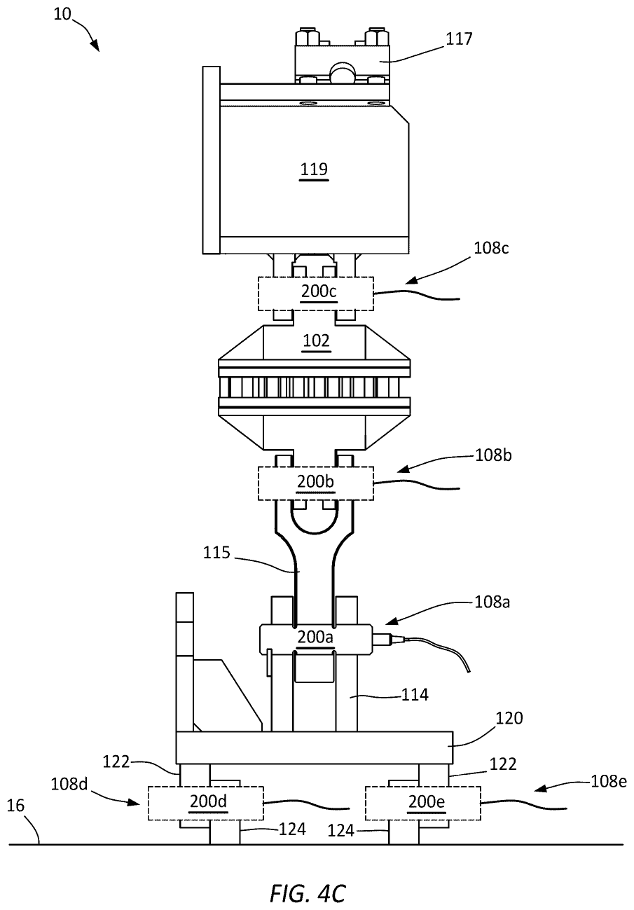

FIG. 4A is a representative perspective view of a deadline anchor 100 with load sensors 102, 200 for measuring forces acting on the deadline anchor 100, in accordance with certain embodiments. The deadline anchor 100 can have a wheel 116 that is rotationally coupled to the base 112 and a structure 119 that can be rotationally coupled to the base 112. The drilling line 46 can be secured by the clamp 117 to the structure 119, with the drilling line 46 extending from the clamp 117, wrapping around the wheel 116 and extending upward to the sheaves 19. When the tension force F5 is applied to the drilling line 46 the wheel 116 can rotate (arrows 190) freely about the axis 90, except that the drilling line 46 is secured by the clamp 117 to the structure 119. The structure 119 is also coupled to the base 112 through the load sensor 102, the link 115, and the structure 114. This coupling prevents rotation of the structure 119 about the axis 90, thereby limiting rotation of the wheel 116 about the axis 90 due to the restriction of the clamp 117.

The deadline anchors 100 in this disclosure are generally directed to a tangent (or tension) configuration of a deadline anchor, where the drilling line 46 is wrapped around the wheel 116 and secured by the clamp 117 in such a way as to put the load sensors 102, 200 in tension when the force F5 is applied to the deadline anchor 100. However, it should be understood that the deadline anchor 100 can also be a compression configuration, where the drilling line 46 is wrapped around the wheel 116 and secured by the clamp 117 in such a way as to put the load sensors 102, 200 in compression when the force F5 is applied to the deadline anchor 100. The discussions in this disclosure about deadline anchors 100 that are in a tangent or tension configuration can also be applicable to the compression deadline anchors.

The top of the load sensor 102 can be coupled to the structure 119 with the bottom of the load sensor 102 coupled to the link 115. The link 115 can be coupled between the structure 114 and the bottom of the load sensor 102, thereby coupling the structure 119 to the base 112. When the tension force F5 is applied to the drilling line 46, the structure 119 applies a force to the top of the load sensor 102, with an equal but opposite reaction force being applied to the bottom of the load sensor 102, due to being coupled to the base 112 through the link 115 and the structure 114. The load sensor 102 can detect the force applied between the structure 119 and the link 115, and generate a signal representative of the force being applied to the load sensor 102. The signal can be a hydraulic pressure signal that can be communicated to a weight indicator which can display an indication of the intensity of the force detected by the load sensor 102. Since the force detected by the load sensor 102 is proportional to the tension force F5 applied to the drilling line 46, then the tension force F5 can be calculated by a rig controller 250 and reported to an operator.

Additionally, a load sensor 200 (e.g., similar to the load sensor 200 in FIGS. 3A-3C) can be used to determine the tension force F5 applied to the drilling line 46. The load sensor 200 can be installed at any of the locations 108a, 108b, 108c shown in FIG. 4A. For example, a load sensor 200 can be installed at the location 108a in a configuration 110a, with the link 115 being the first structure 130 and the structure 114 being the second structure 140. For example, a load sensor 200 can be installed at the location 108b in a configuration 110b, with the bottom of the load sensor 102 being the first structure 130 and the link 115 being the second structure 140. For example, a load sensor 200 can be installed at the location 108c in a configuration 110b, with the top of the load sensor 102 being the first structure 130 and the structure 119 being the second structure 140.

Referring to the example with the load sensor 200 installed at the location 108a, when the tension force F5 is applied to the drilling line 46, the structure 119 applies a force to the top of the load sensor 102, which applies a substantially equal force to the link 115 with an equal but opposite reaction force being applied to the bottom of the link 115, due to being coupled to the base 112 through the structure 114. The load sensor 200, as described regarding FIG. 3A, can measure the force being applied to the load sensor 200 by the link 115. Since this is substantially equal to the force being applied to the load sensor 102 by the structure 119, then the load sensor 200 should provide a measurement that is substantially the same as the force measurements of the load sensor 102. In addition, as described in FIG. 3A, the load sensor 200 can generate one, two, or three signals that are representative of the measured force.

These force measurements can be received at the rig controller 250, which can compare them to determine a confidence score for the measured information. If two of the three force measurements are substantially equal, with one of the three being outside a desired range, then a confidence score can be high that the two measurements, which substantially agree with each other, are accurate measurements, with the one outside of the desired range being classified as being an errored measurement. If all three measurements are substantially equal to each other, then the confidence score can be high thereby indicating the measurements are accurate. The rig controller 250 can use the measurements with a high confidence level to determine the tension force F5 or the hook load F6.

If none of the three measurements are substantially equal, then the confidence score can be low thereby indicating that the measurements are most likely that at least two of the measurements are in error. The measurements (which can also be referred to as sensor data) can be stored in a historical force database 174 for each of the sensors 210, 212 (and possibly one or more additional sensors). The rig controller 250 can analyze the historical force database to determine trends in the sensor data (or measurements) or to validate current measurements. Therefore, when none of the measurements are substantially equal (whether two, three, or more measurements) to each other, the rig controller 250 can compare each of the measurements to their respective historical force database 174 entries to determine which one of the measurements are substantially equal to their respective historical force database 174 entries.

For example, if for the last few minutes, the historical force database 174 entries for one of the sensors show that the current measurement for that sensor is in-line with a trend of the measurements for that sensor or that the current measurement is substantially equal to recent historical force database 174 entries for that sensor. The rig controller 250 can set the confidence level high for the current measurement for that sensor, especially if the current measurements for the other sensors are not substantially equal to their respective historical force database 174 entries or are not in-line with trends for the respective sensor based on the historical force database 174 entries. If additional load sensors are installed at the other locations 108b, 108c, then additional measurements can be used to determine a confidence score for the load sensors 102, 200 sensor data, as well as additional historical force database entries for the additional sensors. The historical force database 174 entries can be used by the rig controller 250 to validate any of the sensor measurements and set a confidence level high for those measurements that correlate to their respective historical force database 174 entries.

For configurations that include more sensors, for those sensors that supply measurements that are substantially equal to each other, the rig controller 250 can set the confidence level for those measurements high and can use those measurements to determine the tension force F5 or the hook load F6. The rig controller 250 can use the hook load F6 to determine the WOB.

The load sensor 200 can incorporate a self-test feature that allows the rig controller 250 to query any one or more of the sensors in the load sensor 200 and receive a response from the one or more sensors that indicates if the one or more sensors are operating correctly. Therefore, when the accuracy of one or more of the sensors 210, 212, etc. of a load sensor 200 is in question, the rig controller 250 can easily assess which of the one or more sensors is operating correctly or incorrectly depending upon the self-test capability of the sensors of the load sensor 200. The self-test results can be used to determine a confidence score for the sensor signals 220, 222, etc. Good self-test results can indicate accurate readings from that sensor, and bad self-test results can indicate inaccurate readings from that sensor.

FIG. 4B is a representative side view of a deadline anchor 100 with load sensors 102, 200 for measuring forces acting on the deadline anchor 100, in accordance with certain embodiments. The deadline anchor 100 is similar to the one shown in FIG. 4A, except that a mounting bracket 120 is used to secure the base 112 to the rig floor 16. The mounting bracket 120 provides additional locations (e.g., locations 108d, 108e) for installing load sensors 200 for detecting the forces acting on the deadline anchor 100.

Having load sensors 200 at possible locations 108a, 108b, 108c has been described above. Load sensors 200 at either of the possible locations 108d, 108e can also detect forces acting on the deadline anchor 100 that are proportional to the tension force F5 acting on the drilling line 46. These can be seen as the configuration 110c for the load sensor 200 at either of the possible locations 108d, 108e.

The mounting bracket 120 can include multiple feet 122 that can protrude downward toward the rig floor 16. Multiple feet 124 can extend upward from the rig floor 16, with each one of the feet 124 overlapping a respective one of the feet 122. Each pair of respective feet 122, 124 can have a bore therethrough that, when aligned, allows an attachment pin or load sensor 200 to be installed therethrough to couple the pair of respective feet 122, 124 together. There can be several pairs of respective feet 122, 124 that provide multiple attachment points for the base 112 to the rig floor 16.

In a non-limiting embodiment, an attachment pin can be installed in the pair of respective feet 122, 124 at location 108e with a load sensor 200 installed in the pair of respective feet 122, 124 at location 108d. When the tension force F5 is applied to the drilling line 46, the deadline anchor 100 is urged to rotate (arrows 192) about the axis 92, thereby applying a tension force F1 to the foot 122 at the location 108d. With the load sensor 200 installed at the location 108d, the tension force F1 will cause an equal and opposite reaction force F2 to resist the tension force F1 and prevent rotation of the deadline anchor 100 about the axis 92. The forces F1, F2 are proportional to the tension force F5 and the load sensor 200 can detect either of the forces F1, F2 and generate a signal to the rig controller 250 that is representative of either of the forces F1, F2. From the signal, the rig controller 250 can determine the actual tension force F5 applied to the drilling line 46 as well as the hook load F6.

In a non-limiting embodiment, an attachment pin can be installed in the pair of respective feet 122, 124 at location 108d with a load sensor 200 installed in the pair of respective feet 122, 124 at location 108e. When the tension force F5 is applied to the drilling line 46, the deadline anchor 100 is urged to rotate (arrows 194) about the axis 94, thereby applying a compression force F1′ to the foot 122 at the location 108e. With the load sensor 200 installed at the location 108e, the compression force F1′ will cause an equal and opposite reaction force F2′ to resist the compression force F1′ and prevent rotation of the deadline anchor 100 about the axis 94. The forces F1′, F2′ are proportional to the tension force F5 and the load sensor 200 can detect either of the forces F1′, F2′ and generate a signal to the rig controller 250 that is representative of either of the forces F1′, F2′. From the signal, the rig controller 250 can determine the actual tension force F5 applied to the drilling line 46 as well as the hook load F6.

FIG. 4C is a representative perspective view of a deadline anchor 100 with load sensors 102, 200 for measuring forces acting on the deadline anchor 100, in accordance with certain embodiments. The deadline anchor 100 is similar to the one shown in FIG. 4B. The mounting bracket 120 provides additional locations (e.g., locations 108d, 108e) for installing load sensors 200 for detecting the forces acting on the deadline anchor 100. A load sensor 200a can be installed at location 108a, which can couple the link 115 to the structure 114. A load sensor 200b can be installed at location 108b, which can couple the link 115 to the bottom of the load sensor 102. A load sensor 200c can be installed at location 108c, which couples the top of the load sensor 102 to the structure 119. A load sensor 200d can be installed at location 108d, which couples a foot 122 of the base 112 to a respective foot 124 of the rig floor 16. A load sensor 200e can be installed at location 108e, which couples another foot 122 of the base 112 to a respective foot 124 of the rig floor 16. As can be seen, several suitable locations for installing a load sensor 200 are available to provide detection of forces acting on the deadline anchor 100, and these detected forces can be used to calculate hook load for the rig 10.

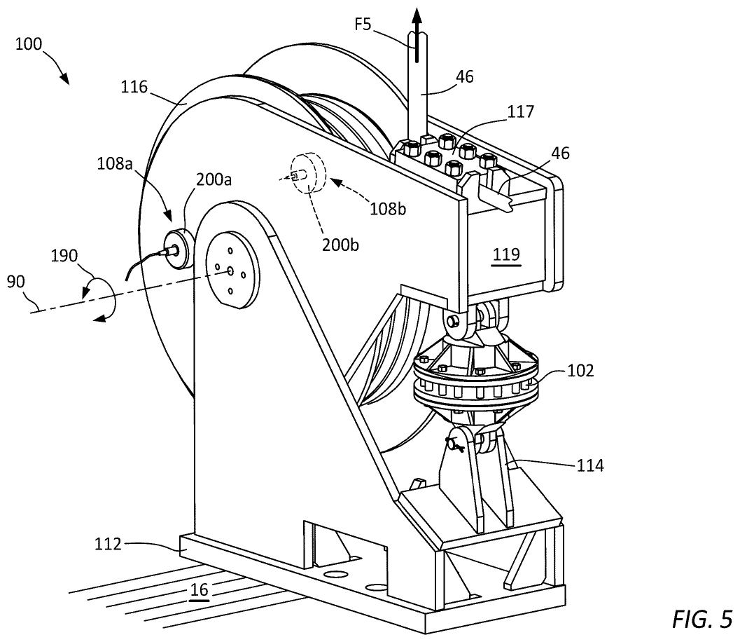

FIG. 5 is a representative perspective view of another deadline anchor 100 with load sensors 102, 200 for measuring forces acting on the deadline anchor 100, in accordance with certain embodiments. FIG. 5 shows various other locations 108 where load sensors 200 can be installed to measure forces acting on the deadline anchor 100. A load sensor 200a is shown installed at a location 108a that traverses through sides of the wheel 116 as well as side plates of the structure 119. The load sensor 200a can couple the wheel 116 to the structure 119, which is also rotationally coupled to the base 112. The load sensor 200a can be installed in a configuration 110b (see FIG. 3B) where the tension force F5 urges the wheel 116 and the structure 119 to rotate about the axis 90, due to the coupling of the wheel 116 to the structure 119 by the load sensor 200a. However, since the structure 119 is coupled to the load sensor 102, it is prevented from rotating. Therefore, the load sensor 200a detects the force trying to rotate the wheel 116 relative to the structure 119, and the load sensor 102 detects the force trying to rotate the structure 119. Both of these forces are proportional to the tension force F5 applied to the drilling line 46 and therefore, can be used to calculate the tension force F5 and the hook load F6.

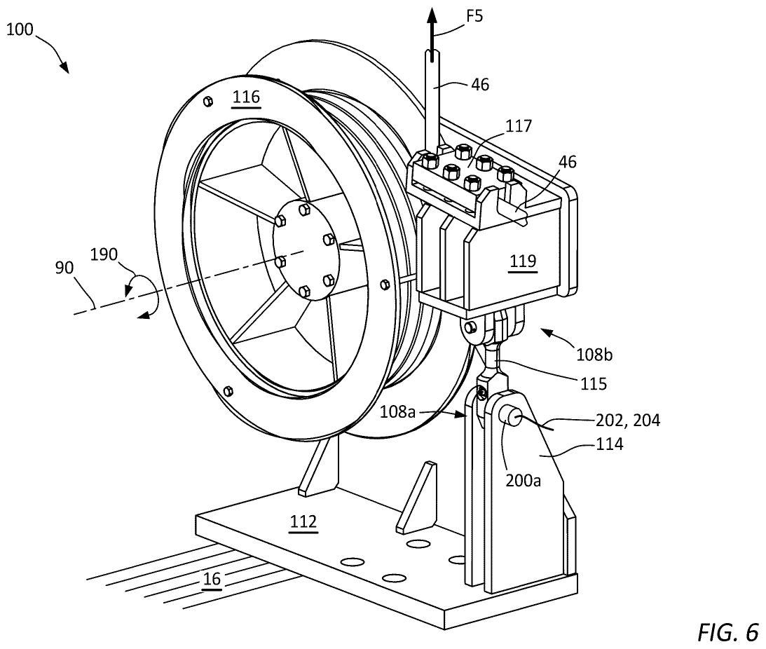

FIG. 6 is a representative perspective view of another deadline anchor 100 with load sensors 200 for measuring forces acting on the deadline anchor 100, in accordance with certain embodiments. In this non-limiting embodiment, the load sensor 102 is not used and the link 115 is used to couple the structure 119 to the structure 114. An attachment pin can be installed at the location 108b and a load sensor 200a can be installed at the location 108a. The load sensor 200a can detect the forces F1, F2, F3, F4 (see FIG. 3A for configuration 110a) and the load sensor 200a can send signals 222, 224 to the rig controller 250 for calculating the tension force F5 or the hook load F6. It should be understood that all load sensors 200 in this description can include one, two, three or more sensors for measuring the forces F1, F2, F3, or F4.

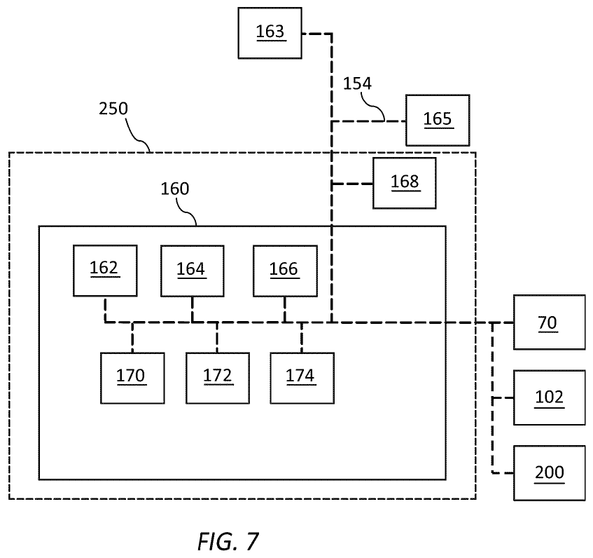

FIG. 7 is a representative functional block diagram of a rig controller 250 that can control rig equipment of the rig 10 and can perform methods of the current disclosure (e.g., determining hook load), in accordance with certain embodiments. The rig controller 250 can include one or more local or remote processing units 160 that can be locally or remotely positioned relative to the rig 10 or downhole. Each processing unit 160 can include one or more processors 162 (e.g., microprocessors, programmable logic arrays, programmable logic devices, etc.), non-transitory memory storage devices 164, peripheral interface 166, human machine interface (HMI) device(s) 168, and possibly a remote telemetry interface 165 for internet communication or satellite network communication. The HMI devices 168 can include devices such as a touchscreen, a laptop, a desktop computer, a workstation, or wearables (e.g., smart phone, smart watch, tablet, etc.). These components of the rig controller 250 can be communicatively coupled together via one or more networks 154, which can be wired or wireless networks.

The processors 162 can be configured to read instructions from one or more non-transitory memory storage devices 164 and execute those instructions to perform any of the methods or operations described in this disclosure. A peripheral interface 166 can be used by the rig controller 250 to receive sensor data from around the rig 10 or downhole which can collect data on the rig operations being performed. The peripheral interface 166 can also be used by the rig controller 250 to send commands to personnel or rig equipment to control rig operations during a subterranean operation. The rig controller 250 can receive a well plan 163 via the network 154 (or peripheral interface 166) and can determine a rig state based on the well plan 163 and data from the sensors 70.

The rig controller 250 can include a hook load module 170 that can determine the hook load from the sensor data from load sensors 102, 200 (e.g., 200a, 200b, 200c, 200d, 200e, etc.). The rig controller 250 can include a WOB module 172 that can determine the WOB, based on calculated hook load F6. The rig controller 250 can determine when a hook load calculation is needed (e.g., based on sensor data received from one or more sensors 70 and the well plan 163), receive signals from the load sensors 102, 200, and then calculate multiple hook loads (via the hook load module 170), where the multiple hook loads include a hook load associated with each load sensor 102, 210, 212, as well as additional load sensors not shown, such as a third or fourth sensor in one or more of the load sensors 200. The rig controller 250 can determine the hook loads when the drill bit 68 is off-bottom and then determine hook loads when the drill bit 68 is on-bottom. The WOB module 172 can calculate the WOB from each of the hook loads by calculating the change in hook load from when the drill bit 68 is off-bottom to when it is on-bottom. The historical force database 174 can store historical values for hook loads, force values, WOB values, sensor signals, etc. The rig controller 250 can store new force values in the database 174 as well as used the historical force database 174 entries to validate real-time force calculations, such as hook load F6, WOB, etc.

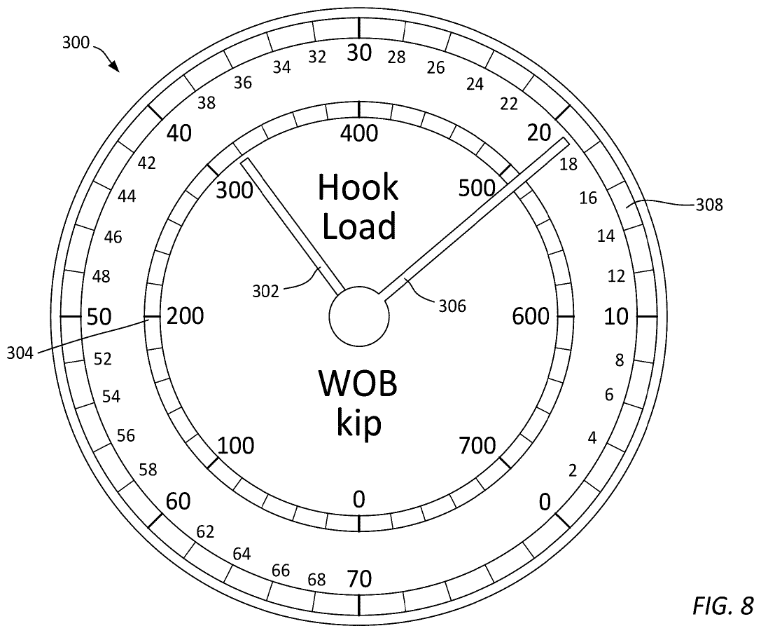

FIG. 8 is a representative front view of an example graphic user interface display 300 for displaying hook load F6 and WOB to the operator. This GUI 300 receives information from the rig controller 250 (e.g., hook load F6, WOB) and displays the information on an operator display via the GUI 300. The GUI 300 includes a dial 304 and a needle 302 for indicating hook load F6. The GUI 300 also includes a dial 308 and a needle 306 for indicating WOB.

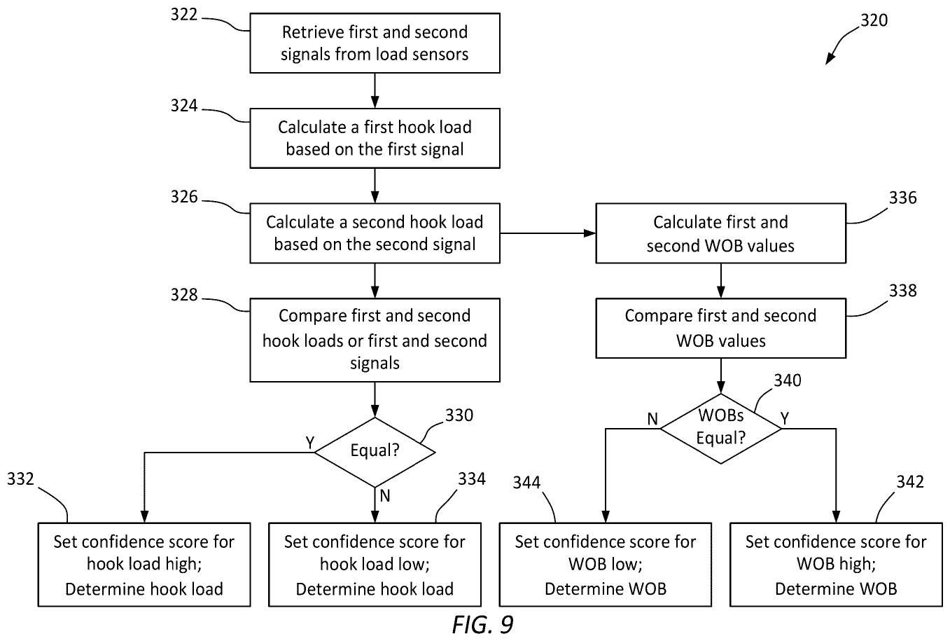

FIG. 9 is a representative flow chart for a method 320 for determining confidence scores for hook load and WOB values. In operation 322, the rig controller 250 can retrieve signals from the first and second load sensors 102, 210, 212, where the signals or representative of the tension force F5. In operation 324, the rig controller 250 can calculate a first hook load from the first signal from the first sensor 102, 210, or 212. Since the first signal is proportional to the hook load, the rig controller 250 can apply a coefficient to the first signal to determine the hook load represented by the first signal or determine the first hook load based on the first signal via another suitable method. In operation 326, the rig controller 250 can calculate a second hook load from the second signal from the second sensor 102, 210, or 212. Since the second signal is proportional to the hook load, the rig controller 250 can apply a coefficient to the second signal to determine the hook load represented by the second signal or determine the second hook load based on the second signal via another suitable method.

In operation 328, the rig controller 250 can compare the first and second hook loads or the first and second signals to determine if they are substantially equal to each other or if they are not substantially equal to each other. In operation 330, if the hook loads (or the first and second signals) are substantially equal, then the method can progress to operation 332, where the rig controller 250 can determine that a confidence score of the hook loads is high (i.e., above a pre-determined threshold value). In operation 330, if the hook loads (or the first and second signals) are not substantially equal, then the method can progress to operation 334, where the rig controller 250 can determine that a confidence score of the hook loads is low (i.e., below a pre-determined threshold value). The confidence score can be displayed to the operator to indicate whether or not the hook load values are to be relied upon or not.

If the first and second hook loads (or the first and second signals) are not substantially equal to each other, then the historical sensor database entries for the first and second hook loads (or the first and second signals) can be analyzed by the rig controller 250 to determine which of the first and second hook loads (or the first and second signals) are accurate values based on comparing the first and second hook loads (or the first and second signals) to the respective historical force database 174 entries. The rig controller 250 can then use the values (hook loads, signals, etc.), which are indicated as being accurate by having a high confidence level assigned to them, to determine the hook load F6 to be reported to other processes on the rig, or remote, or to local or remote operators or users. The WOB can also be calculated after the hook load F6 has been determined, as opposed to calculating first and second WOBs and comparing them to themselves or to historical values.

In operation 336, the rig controller 250 can calculate first and second WOB values based on the first and second hook load values. In operation 338, the rig controller 250 can compare the first and second WOB values to determine if they are substantially equal to each other or if they are not substantially equal to each other. In operation 340, if the WOB values are substantially equal, then the method can progress to operation 342, where the rig controller 250 can determine that a confidence score of the WOB values is high (i.e., above a pre-determined threshold value). In operation 340, if the WOB values are not substantially equal, then the method can progress to operation 344, where the rig controller 250 can determine that a confidence score of the WOB values is low (i.e., below a pre-determined threshold value). The confidence score can be displayed to the operator to indicate whether or not the WOB values are to be relied upon or not. This method can be performed during drilling operations and can allow the operator to have a redundancy check on the hook load F6 and WOB possibly without running calibration tests.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, “generally”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

As used herein, “tubular” refers to an elongated cylindrical tube and can include any of the tubulars manipulated around a rig, such as tubular segments, tubular stands, tubulars, and tubular string, but not limited to the tubulars shown in FIG. 1A. Therefore, in this disclosure, “tubular” is synonymous with “tubular segment,” “tubular stand,” and “tubular string,” as well as “pipe,” “pipe segment,” “pipe stand,” “pipe string,” “casing string,” “coiled tubing”, or “wireline.”

It should be noted that the X-Y-Z coordinate axes are indicated in FIGS. XX and XX, where the X-Y-Z coordinate axes are relative to the rig floor 16. The rig floor 16 forms an X-Y plane with the Z axis being substantially perpendicular with the rig floor 16. As used herein, “horizontal,” “horizontal position,” or “horizontal orientation” refers to a position that is substantially parallel with the X-Y plane. As used herein, “vertical,” “vertical position,” or “vertical orientation” refers to a position that is substantially perpendicular relative to the X-Y plane or substantially parallel with the Z axis.

### Various Embodiments

Embodiment 1. A deadline anchor comprising:
a base structure coupled to a rig floor;
a wheel rotatably coupled to the base structure;
a first sensor coupled to the deadline anchor at a first location, wherein the first sensor is configured to detect a first force applied to the first sensor; and
a second sensor coupled to the deadline anchor at a second location, wherein the second sensor is configured to detect a second force applied to the second sensor.

Embodiment 2. The deadline anchor of embodiment 1, wherein application of a tension force to the wheel urges rotation of the wheel relative to the base structure, and wherein the first force and the second force are applied to the first sensor and the second sensor, respectively, in response to the application of the tension force.

Embodiment 3. The deadline anchor of embodiment 2, further comprising a rig controller, wherein the first sensor transmits a first signal to the rig controller, the first signal being representative of the first force detected by the first sensor, and wherein the second sensor transmits a second signal to the rig controller, the second signal being representative of the second force detected by the second sensor.

Embodiment 4. The deadline anchor of embodiment 3, wherein a rig controller is configured to determine a first estimated hook load based on the first signal and a second estimated hook load based on the second signal.

Embodiment 5. The deadline anchor of embodiment 4, wherein the rig controller is configured to determine an actual hook load based on the first estimated hook load or the second estimated hook load.

Embodiment 6. The deadline anchor of embodiment 5, wherein the rig controller is configured to compare the first estimated hook load and the second estimated hook load and determine a confidence score for the actual hook load based on at least one of the first estimated hook load, the second estimated hook load, and the comparison.

Embodiment 7. The deadline anchor of embodiment 4, wherein the rig controller is configured to determine an actual hook load based on the first estimated hook load, the second estimated hook load, and at least one historical value of the first estimated hook load or the second estimated hook load.

Embodiment 8. The deadline anchor of embodiment 7, wherein the rig controller is configured to compare the first estimated hook load, the second estimated hook load, and the at least one historical value, and determine a confidence score for the actual hook load based on at least one of the first estimated hook load, the second estimated hook load, the at least one historical value, and the comparison.

Embodiment 9. The deadline anchor of embodiment 8, wherein the rig controller is configured to display the actual hook load to an operator via a graphical user interface (GUI).

Embodiment 10. The deadline anchor of embodiment 8, wherein the rig controller is configured to display the confidence score to an operator via a graphical user interface (GUI).

Embodiment 11. The deadline anchor of embodiment 4, wherein the rig controller is configured to determine a first estimated weight on bit (WOB) based on the first estimated hook load and a second estimated WOB based on the second estimated hook load.

Embodiment 12. The deadline anchor of embodiment 11, wherein the rig controller is configured to determine an actual WOB based on at least one of the first estimated WOB, the second estimated WOB, and at least one historical value of the first estimated WOB or the second estimated WOB.

Embodiment 13. The deadline anchor of embodiment 12, wherein the rig controller is configured to compare the first estimated WOB, the second estimated WOB, and the at least one historical value, and determine a confidence score for the actual WOB based on at least one of the first estimated WOB, the second estimated WOB, the at least one historical value, and the comparison.

Embodiment 14. The deadline anchor of embodiment 13, wherein the rig controller is configured to display the actual WOB to an operator via a graphical user interface (GUI).

Embodiment 15. The deadline anchor of embodiment 13, wherein the rig controller is configured to display the confidence score to an operator via a graphical user interface (GUI).

Embodiment 16. The deadline anchor of embodiment 1, wherein the first location is spaced apart from the second location.

Embodiment 17. The deadline anchor of embodiment 1, further comprising a clamp that secures a drilling line to a rotatable support structure, wherein the rotatable support structure is rotationally fixed to the wheel.

Embodiment 18. The deadline anchor of embodiment 17, wherein application of a tension force to the drilling line urges rotation of the rotatable support structure relative to the base structure, and wherein the first force and the second force are applied to the first sensor and the second sensor, respectively, in response to the application of the tension force.

Embodiment 19. The deadline anchor of embodiment 18, wherein the tension force is representative of a hook load, and wherein the hook load is a weight being supported by a traveling block of a rig.

Embodiment 20. The deadline anchor of embodiment 1, wherein the first force and the second force urge rotation of the wheel relative to the base structure.

Embodiment 21. The deadline anchor of embodiment 1, wherein the first sensor transmits, to a rig controller, a first signal that is representative of the first force, and wherein the second sensor transmits, to the rig controller, a second signal that is representative of the second force.

Embodiment 22. The deadline anchor of embodiment 21, wherein the rig controller is configured to determine a tension force that acts on a drilling line based on either the first signal or the second signal.

Embodiment 23. The deadline anchor of embodiment 22, wherein the rig controller is configured to compare the first signal and the second signal and determine if either of the first signal or the second signal is outside of a pre-determined range.

Embodiment 24. The deadline anchor of embodiment 22, wherein the rig controller is configured to determine a confidence score for the tension force based on whether the first signal or the second signal is within a pre-determined range.

Embodiment 25. The deadline anchor of embodiment 21, further comprising:
a third sensor coupled to the deadline anchor at a third location, wherein the third sensor is configured to detect a third force applied to the third sensor, wherein the third sensor transmits, to the rig controller, a third signal that is representative of the third force.

Embodiment 26. The deadline anchor of embodiment 25, wherein the rig controller is configured to determine a tension force that acts on a drilling line based on at least one of the first signal, the second signal, and the third signal.

Embodiment 27. The deadline anchor of embodiment 26, wherein the rig controller is configured to compare the first signal, the second signal, and the third signal and determine if either of the first signal or the second signal or the third signal is outside of a pre-determined range.

Embodiment 28. The deadline anchor of embodiment 26, wherein the rig controller is configured to compare the first signal, the second signal, and the third signal to each other and determine whether any one of the first signal, the second signal, and the third signal is substantially equal to another one of the first signal, the second signal, and the third signal.

Embodiment 29. The deadline anchor of embodiment 28, wherein if two or more of the first signal, the second signal, and the third signal are substantially equal, the rig controller is configured to determine that the two or more of the first signal, the second signal, and the third signal from corresponding two or more of the first sensor, the second sensor, and third sensor are accurate.

Embodiment 30. The deadline anchor of embodiment 29, wherein the rig controller is configured to determine a hook load based on the two or more of the first signal, the second signal, and the third signal that are substantially equal to each other.

Embodiment 31. A system for determining hook load, the system comprising:
a drilling line coupled to a drawworks at one end and to a deadline anchor at an opposite end, the deadline anchor comprising:
a base structure coupled to a rig floor;
a wheel rotatably coupled to the base structure;
a first sensor coupled to the wheel at a first location, wherein the first sensor detects a first force that is proportional to a tension force applied to the deadline anchor via the drilling line; and
a second sensor coupled to the wheel at a second location, wherein the second sensor detects a second force that is proportional to the tension force.

Embodiment 32. The system of embodiment 31, wherein the first location is spaced apart from the second location.

Embodiment 33. The system of embodiment 31, wherein the first sensor is coupled to the base structure at the first location and the second sensor is coupled to the base structure at the second location.

Embodiment 34. The system of embodiment 31, wherein the tension force is proportional to an actual hook load.

Embodiment 35. The system of embodiment 34, further comprising:
a rig controller, wherein the rig controller is configured to determine a first estimated hook load based on the first force and a second estimated hook load based on the second force.

Embodiment 36. The system of embodiment 35, wherein the first force is substantially equal to the second force, which indicates that the detections of the first sensor and the second sensor are accurate.

Embodiment 37. The system of embodiment 35, wherein the first force is not substantially equal to the second force, which indicates that at least one of the detections of the first sensor and the second sensor are inaccurate.

Embodiment 38. The system of embodiment 35, wherein the rig controller is configured to determine a first estimated WOB based on the first estimated hook load, and to determine a second estimated WOB based on the second estimated hook load.

Embodiment 39. The system of embodiment 38, wherein the first estimated WOB is substantially equal to the second estimated WOB, which indicates that the detections of the first sensor and the second sensor are accurate.

Embodiment 40. A method for verifying hook load, the method comprising:
coupling a first sensor to a deadline anchor at a first location;
coupling a second sensor to the deadline anchor at a second location;
applying a tension force to the deadline anchor, wherein the tension force is proportional to an actual hook load;
detecting a first force, via the first sensor, in response to applying the tension force; and
detecting a second force, via the second sensor, in response to applying the tension force.

Embodiment 41. The method of embodiment 40, wherein the first location is the same as the second location.

Embodiment 42. The method of embodiment 40, wherein the first location is spaced apart from the second location.

Embodiment 43. The method of embodiment 40, further comprising:
receiving, at a rig controller, first sensor data from the first sensor, wherein the first sensor data is representative of the first force; and
receiving, at the rig controller, second sensor data from the second sensor, wherein the second sensor data is representative of the second force.

Embodiment 44. The method of embodiment 43, further comprising:
comparing, via a rig controller, the first force to the second force; and determining, via the rig controller, the actual hook load based on the first force or the second force when the first force is substantially equal to the second force.

Embodiment 45. The method of embodiment 43, further comprising:
comparing, via the rig controller, the first force to the second force; and
determining, via the rig controller, the actual hook load based on the first force when the first force is not substantially equal to the second force, and the first force is substantially equal to a historical value of the first force.

Embodiment 46. The method of embodiment 43, further comprising:
comparing, via the rig controller, the first force to the second force; and
determining, via the rig controller, the actual hook load based on the second force when the first force is not substantially equal to the second force, and the second force is substantially equal to a historical value of the second force.

Embodiment 47. The method of embodiment 43, further comprising:
coupling a third sensor to a deadline anchor at a third location; and
detecting a third force, via the third sensor, in response to applying the tension force.

Embodiment 48. The method of embodiment 47, wherein the second location is the same as the third location.

Embodiment 49. The method of embodiment 47, wherein the first location is spaced apart from the second location and the second location is spaced apart from the third location.

Embodiment 50. The method of embodiment 47, further comprising:
receiving, at a rig controller, third sensor data from the third sensor, wherein the third sensor data is representative of the third force.

Embodiment 51. The method of embodiment 50, further comprising:
comparing, via the rig controller, the first force, the second force, and the third force; and
determining, via the rig controller, the actual hook load based on one or more of the first force, the second force, and the third force when the first force, the second force, and the third force are substantially equal to each other.

Embodiment 52. The method of embodiment 50, further comprising:
comparing, via the rig controller, the first force, the second force, and the third force; and
determining, via the rig controller, the actual hook load based on one or more of the first force and the second force, when the first force and the second force are substantially equal to each other, and the third force is not substantially equal to either one of the first force or the second force.

Embodiment 53. The method of embodiment 50, further comprising:
comparing, via the rig controller, the first force, the second force, and the third force; and
determining, via the rig controller, the actual hook load based on one or more of the first force, the second force, and the third force when the first force, the second force, and the third force are not substantially equal to each other, and one of the first force, the second force, and the third force is substantially equal to a historical value of the one of the first force, the second force, and the third force.

Embodiment 54. A method for verifying hook load, the method comprising:
coupling a first sensor to a deadline anchor at a first location;
coupling a second sensor to the deadline anchor at a second location;
applying a tension force to the deadline anchor, wherein the tension force is proportional to an actual hook load;
detecting a first force, via the first sensor, in response to applying the tension force; and
detecting a second force, via the second sensor, in response to applying the tension force.

Embodiment 55. The method of embodiment 54, wherein the first location is the same as the second location.

Embodiment 56. The method of embodiment 54, wherein the first location is spaced apart from the second location.

Embodiment 57. The method of embodiment 54, further comprising:
receiving, at a rig controller, first sensor data from the first sensor, wherein the first sensor data is representative of the first force;
determining, via the rig controller, a first estimated hook load based on the first sensor data;
receiving, at the rig controller, second sensor data from the second sensor, wherein the second sensor data is representative of the second force; and
determining, via the rig controller, a second estimated hook load based on the second sensor data.

Embodiment 58. The method of embodiment 57, further comprising:
comparing, via the rig controller, the first estimated hook load to the second estimated hook load; and
determining, via the rig controller, the actual hook load based on the first estimated hook load or the second estimated hook load when the first estimated hook load is substantially equal to the second estimated hook load.

Embodiment 59. The method of embodiment 57, further comprising:
comparing, via the rig controller, the first estimated hook load to the second estimated hook load; and
determining, via the rig controller, the actual hook load based on the first estimated hook load when the first estimated hook load is not substantially equal to the second estimated hook load, and the first estimated hook load is substantially equal to a historical value of the first estimated hook load.

Embodiment 60. The method of embodiment 57, further comprising:
comparing, via the rig controller, the first estimated hook load to the second estimated hook load; and
determining, via the rig controller, the actual hook load based on the second estimated hook load when the first estimated hook load is not substantially equal to the second estimated hook load, and the second estimated hook load is substantially equal to a historical value of the second estimated hook load.

Embodiment 61. The method of embodiment 57, further comprising:
coupling a third sensor to a deadline anchor at a third location; and detecting a third force, via the third sensor, in response to applying the tension force.

Embodiment 62. The method of embodiment 61, wherein the second location is the same as the third location.

Embodiment 63. The method of embodiment 61, wherein the first location is spaced apart from the second location and the second location is spaced apart from the third location.

Embodiment 64. The method of embodiment 61, further comprising:
receiving, at a rig controller, third sensor data from the third sensor, wherein the third sensor data is representative of the third force; and determining, via the rig controller, a third estimated hook load based on the third sensor data.

Embodiment 65. The method of embodiment 64, further comprising:
comparing, via the rig controller, the first estimated hook load, the second estimated hook load, and the third estimated hook load; and
determining, via the rig controller, the actual hook load based on one or more of the first estimated hook load, the second estimated hook load, and the third estimated hook load when the first estimated hook load, the second estimated hook load, and the third estimated hook load are substantially equal to each other.

Embodiment 66. The method of embodiment 64, further comprising:
comparing, via the rig controller, the first estimated hook load, the second estimated hook load, and the third estimated hook load; and
determining, via the rig controller, the actual hook load based on one or more of the first estimated hook load and the second estimated hook load, when the first estimated hook load and the second estimated hook load are substantially equal to each other, and the third estimated hook load is not substantially equal to either one of the first estimated hook load or the second estimated hook load.

Embodiment 67. The method of embodiment 64, further comprising:
comparing, via the rig controller, the first estimated hook load, the second estimated hook load, and the third estimated hook load; and
determining, via the rig controller, the actual hook load based on one or more of the first estimated hook load, the second estimated hook load, and the third estimated hook load when the first estimated hook load, the second estimated hook load, and the third estimated hook load are not substantially equal to each other, and one of the first estimated hook load, the second estimated hook load, and the third estimated hook load is substantially equal to a historical value of the one of the first estimated hook load, the second estimated hook load, and the third estimated hook load.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

What is claimed is:

1. A deadline anchor comprising:
a base structure coupled to a rig floor;
a wheel rotatably coupled to the base structure, wherein a drilling line is wrapped around the wheel and urges rotation of the wheel when a tension force is applied to the drilling line, and wherein the drilling line is configured to be coupled to a drawworks at one end and coupled to the wheel proximate an opposite end;
a first sensor coupled to the deadline anchor at a first location, wherein the first sensor is configured to detect a first force applied to the first sensor; and
a second sensor coupled to the deadline anchor at a second location, wherein the second sensor is configured to detect a second force applied to the second sensor.

2. The deadline anchor of claim 1, wherein application of the tension force to the wheel urges rotation of the wheel relative to the base structure, and wherein the first force and the second force are applied to the first sensor and the second sensor, respectively, in response to the application of the tension force.

3. The deadline anchor of claim 2, further comprising a rig controller, wherein the first sensor transmits a first signal to the rig controller, the first signal being representative of the first force detected by the first sensor, and wherein the second sensor transmits a second signal to the rig controller, the second signal being representative of the second force detected by the second sensor.

4. The deadline anchor of claim 3, wherein a rig controller is configured to determine a first estimated hook load based on the first signal and a second estimated hook load based on the second signal.

5. The deadline anchor of claim 4, wherein the rig controller is configured to determine an actual hook load based on the first estimated hook load or the second estimated hook load, and wherein the rig controller is configured to display the actual hook load on a graphical user interface (GUI).

6. The deadline anchor of claim 5, wherein the rig controller is configured to compare the first estimated hook load and the second estimated hook load and determine a confidence score for the actual hook load based on at least one of the first estimated hook load, the second estimated hook load, at least one historical value of hook load, and the comparison.

7. The deadline anchor of claim 6, wherein the rig controller is configured to display the confidence score on a graphical user interface (GUI).

8. The deadline anchor of claim 4, wherein the rig controller is configured to:
determine a first estimated weight on bit (WOB) based on the first estimated hook load,
determine a second estimated WOB based on the second estimated hook load,
determine an actual WOB based on the first estimate WOB and the second estimated WOB,
determine a confidence score for the actual WOB based on at least one of the first estimated WOB, the second estimated WOB, and at least one historical value, and
display the actual WOB and the confidence score on a graphical user interface (GUI).

9. The deadline anchor of claim 1, wherein the first sensor transmits, to a rig controller, a first signal that is representative of the first force, and wherein the second sensor transmits, to the rig controller, a second signal that is representative of the second force, wherein the rig controller is configured to determine a tension force that acts on a drilling line based on either the first signal or the second signal, and wherein the rig controller is configured to compare the first signal and the second signal and determine if either of the first signal or the second signal is outside of a pre-determined range.

10. The deadline anchor of claim 9, further comprising:
a third sensor coupled to the deadline anchor at a third location, wherein the third sensor is configured to detect a third force applied to the third sensor,
wherein the third sensor transmits, to the rig controller, a third signal that is representative of the third force, wherein the rig controller is configured to determine a tension force that acts on a drilling line based on at least one of the first signal, the second signal, and the third signal, and
wherein the rig controller is configured to compare the first signal, the second signal, and the third signal and determine if either of the first signal or the second signal or the third signal is outside of a pre-determined range, or the rig controller is configured to compare the first signal, the second signal, and the third signal to each other and determine whether any one of the first signal, the second signal, and the third signal is substantially equal to another one of the first signal, the second signal, and the third signal.

11. A system for determining hook load, the system comprising:
a drilling line coupled to a drawworks at one end and to a deadline anchor at an opposite end, the deadline anchor comprising:
a base structure coupled to a rig floor;
a wheel rotatably coupled to the base structure;
a first sensor coupled to the wheel at a first location, wherein the first sensor detects a first force that is proportional to a tension force applied to the deadline anchor via the drilling line; and
a second sensor coupled to the wheel at a second location, wherein the second sensor detects a second force that is proportional to the tension force.

12. The system of claim 11, wherein the first location is spaced apart from the second location, and wherein the tension force is proportional to an actual hook load.

13. The system of claim 12, further comprising:
a rig controller, wherein the rig controller is configured to determine a first estimated hook load based on the first force and a second estimated hook load based on the second force.

14. The system of claim 13, wherein the first force is substantially equal to the second force, which indicates that the detections of the first sensor and the second sensor are accurate.

15. The system of claim 13, wherein the first force is not substantially equal to the second force, which indicates that at least one of the detections of the first sensor and the second sensor are inaccurate.

16. A method for verifying hook load, the method comprising:
coupling a first sensor to a deadline anchor at a first location;
coupling a second sensor to the deadline anchor at a second location;
applying a tension force to the deadline anchor, wherein the tension force is proportional to an actual hook load;
detecting a first force, via the first sensor, in response to applying the tension force; and
detecting a second force, via the second sensor, in response to applying the tension force.

17. The method of claim 16, further comprising:
receiving, at a rig controller, first sensor data from the first sensor, wherein the first sensor data is representative of the first force; and
receiving, at the rig controller, second sensor data from the second sensor, wherein the second sensor data is representative of the second force.

18. The method of claim 17, further comprising:
comparing, via a rig controller, the first force to the second force; and
determining, via the rig controller:
the actual hook load based on the first force or the second force when the first force is substantially equal to the second force,
the actual hook load based on the first force when the first force is not substantially equal to the second force, and the first force is substantially equal to a historical value of the first force, or
the actual hook load based on the second force when the first force is not substantially equal to the second force, and the second force is substantially equal to a historical value of the second force.

19. The method of claim 17, further comprising:
coupling a third sensor to a deadline anchor at a third location;
detecting a third force, via the third sensor, in response to applying the tension force; and
receiving, at a rig controller, third sensor data from the third sensor, wherein the third sensor data is representative of the third force.

20. The method of claim 19, further comprising:
comparing, via the rig controller, the first force, the second force, and the third force; and
determining, via the rig controller:
the actual hook load based on one or more of the first force, the second force, and the third force when the first force, the second force, and the third force are substantially equal to each other,
the actual hook load based on one or more of the first force and the second force, when the first force and the second force are substantially equal to each other, and the third force is not substantially equal to either one of the first force or the second force, or
the actual hook load based on one or more of the first force, the second force, and the third force when the first force, the second force, and the third force are not substantially equal to each other, and one of the first force, the second force, and the third force is substantially equal to a historical value of the one of the first force, the second force, and the third force.
